(19) United States
(12) Patent Application Publication
(10) Pub. No.: US 2012/0183855 A1
(43) Pub. Date: Jul. 19, 2012

(54) Positive active electrode material for lithium secondary battery, process for preparing the same and lithium secondary battery

(75) Inventors: Margret Wohlfahrt-Mehrens, Illertissen (DE); Peter Axmann, Erbach (DE); Wolfgang Weirather, Dornstadt (DE); Karl Kohler, Diekholzen (DE)

(73) Assignee: SOLVAY SA, Brussels (BE)

(21) Appl. No.: 13/498,790

(22) PCT Filed: Sep. 27, 2010
(86) PCT No.: PCT/EP10/64224

§ 371 Date: Mar. 28, 2012

(30) Foreign Application Priority Data
Sep. 30, 2009 (EP) 09171841.1

(51) Int. Cl. H01M 10/05; H01M 4/525; H01M 4/505; H01M 4/485; H01M 4/131

(52) U.S. Cl. 429/221; 429/223; 252/182.1

(57) ABSTRACT

Positive active electrode material for lithium secondary batteries comprising a mixed oxide represented by the general formula LiᵥNi_{w}MnₓCo_{y}Al_{z}O₂ wherein 0.9≦v≦1.2, 0.34≦w≦0.49, 0.34≦x≦0.42, 0.08≦y≦0.20, 0.03≦z≦0.05, 0.8≦w/x≦1.8, −0.08≦w−x≦0.22, 0.12≦y+z≦0.25 and w+x+y+z=1.

### CROSS-REFERENCE TO RELATED APPLICATIONS

The present application is a U.S. national stage entry under 35 U.S.C. §371 of International Application No. PCT/EP2010/064224 filed Sep. 27, 2010, which claims the benefit of the European application no. 09171841.1 filed on Sep. 30, 2009, the whole content of this application being herein incorporated by reference for all purposes.

### TECHNICAL FIELD OF THE INVENTION

The present invention relates to a positive active electrode material for lithium secondary batteries, a process for preparing the same, and lithium secondary batteries comprising the same.

### BACKGROUND

Non-aqueous electrolyte batteries, such as lithium secondary batteries, also named rechargeable lithium ion batteries, in which material capable of reversible intercalation of lithium ions is used as an electrode material, are known in the art. Such batteries exhibit a higher battery voltage and a higher energy density compared to aqueous type batteries such as lead batteries, nickel-cadmium batteries and nickel-hydrogen batteries. Lithium secondary batteries also have no memory effect and do not contain the poisonous metal elements mercury, lead, and cadmium.

Said batteries are used in many applications, amongst which as supply electric sources for portable electronics, such as notebooks, laptops, mobile phones etc. Said batteries are also growing in popularity for defense, automotive and aerospace applications, due to their high energy density. There is thus a need for lithium secondary batteries having a high performance, especially a high energy density and a high battery voltage, but also a good thermal stability and good cycle characteristics, i.e. a good reversibility of the lithium-insertion and -deinsertion processes of positive and negative active materials.

As positive active electrode materials for use in lithium secondary batteries, it is known to use, among others, mixed oxides of lithium and other metals, such as LiCoO₂, LiMn₂O₄, LiMnO₂, LiNiO₂, LiNi₁₋ₓCoₓO₂ (0<x<1). More and more mixed oxides comprising lithium and at least two other metals are currently used. For instance, as disclosed in US 2008/0248397 A1, positive active electrode materials may be selected, among others, from compounds of formula Liₐ₁Ni_{b1}Co_{c1}M1_{d1}O₂ wherein 0.95≦a1≦1.1, 0≦b1≦0.9, 0≦c1≦0.5 and 0≦d1≦0.2 and M1 is selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Ru, Os, Hs, Rh, Ir, Pd, Pt, Cu, Ag, Au, Zn, Cd, B, Al, Ga, In, Tl, Si, Ge, Sn, P, As, Sb, Bi, S, Se, Te, Po and mixtures thereof. Still according to US 2008/0248397 A1, positive active electrode materials may be selected from compounds of formula Liₐ₂Ni_{b2}Co_{c2}Mn_{d2}M2ₑ₁O₂ wherein 0.95≦a2≦1.1, 0≦b2 0.9, 0≦c2≦0.5, 0≦d2≦0.5 and 0≦e1≦0.2 and M2 is selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Ru, Os, Hs, Rh, Ir, Pd, Pt, Cu, Ag, Au, Zn, Cd, B, Al, Ga, In, Tl, Si, Ge, Sn, P, As, Sb, Bi, S, Se, Te, Po, and mixtures thereof.

Other examples of mixed oxides comprising lithium, useful as positive active electrode materials, are disclosed in JP 2003/31219 A, which discloses oxides of formula Li(ᵢ₊ₐ)MnₓNi_{y}Co_{z}M_{b}O₂ wherein M is an element different from Mn, Ni, Co and Li, 0≦a≦0.1, −0.1≦x−y0.1, y≦x+z+b, 0<z≦0.4, 0.3≦x, 0.3≦y, and x+y+z+b=1.

Even if many different mixed oxides have already been developed, there is still a need for new mixed oxides showing a high performance, especially a high energy density and a high battery voltage, a high thermal stability and supporting numerous charging/discharging cycles, while having a limited cost.

### SUMMARY OF THE INVENTION

The purpose of the present invention is to provide specific mixed oxides that have particularly advantageous properties, especially which allow the preparation of positive electrodes for lithium secondary batteries, said positive electrodes being high in energy density, in conductivity and in voltage, and having a good thermal stability and good cycle characteristics, while being of reasonable cost.

The present invention therefore relates to positive active electrode material for lithium secondary batteries comprising a mixed oxide represented by the general formula

LiᵥNi_{w}MnₓCo_{y}Al_{z}O₂

wherein
0.9≦v≦1.2,
0.34≦w≦0.49,
0.34≦x≦0.42,
0.08≦y≦0.20,
0.03≦z<0.05,
0.8≦w/x≦1.8,
−0.08≦w−x≦0.22,
0.12≦y+z≦0.25 and
w+x+y+z=1.

Indeed, it has been surprisingly found that mixed oxides of this general formula exhibit a good specific capacity and an improved safety from the point of thermal stability in the charged state, while being of reasonable cost, for example compared to LiCoO₂ or LiNi_{1/3}Mn_{1/3}Co_{1/3}O₂. The mixed oxides of the present invention thus allow the preparation of lithium secondary batteries having
an improved safety
good capacity
a limited cost.

One of the essential features of the present invention resides in the presence of Al in the mixed oxide composition. An advantage linked to the choice of Al, for example instead of B, is that it can occupy Ni, Co or Mn positions in the α-NaFeO₂ structure. Another advantage is that Al is not oxidizable thus holding back equivalent amounts of the Li in the structure and stabilizing the material in the charged state. Compared to the divalent Mg that retains two equivalents of Li, Al holds back only one equivalent of Li. Thus the effect of reducing the capacity by fixing Li is less pronounced for Al. Last but not least, compared to Cr, Al is a non toxic element.

Another essential feature of the present invention resides in the stoichiometric amounts of the metals present in the mixed oxide. In the present invention, the stoichiometric amount of lithium (Li) in the mixed oxide is preferably such that 0.95≦v≦1.1, more preferably such that 1≦v≦1.1, for example v is equal to about 1. The stoichiometric amount of nickel (Ni) in the mixed oxide of the present invention is advantageously 0.36≦w≦0.46, especially 0.38≦w≦0.42. The stoichiometric amount of manganese (Mn) is with especial preference 0.38≦x≦0.42. The stoichiometric amount of cobalt (Co) is in particular 0.12≦y≦0.2. The stoichiometric amount of aluminum (Al) is with higher preference 0.04≦z<0.05.

### BRIEF DESCRIPTION OF THE DRAWINGS

For a detailed description of preferred embodiments of the invention, reference will now be made to the accompanying drawings, in which:

FIG. 1 shows a X-Ray Diffraction graph of a (Li,Ni,Mn,Co,Al)-oxide example with an α-NaFeO₂ structure type, said mixed oxide being made by a precipitation process;

FIGS. 2 and 3 illustrate the electrochemical behavior tested by galvanostatic cycling of two material examples of (Li,Ni,Mn,Co,Al)-oxide made by a precipitation process; and

FIGS. 4 and 5 illustrate the electrochemical behavior tested by galvanostatic cycling of two material examples of (Li,Ni,Mn,Co,A1)-oxide made by a spray-roasting process.

### DETAILED DESCRIPTION OF THE PREFERRED EMBODIMENTS

According to preferred embodiments, the ratio nickel / manganese (w/x) is from 0.9 to 1.1, preferably about 1 and/or the sum cobalt plus aluminum (y+z) is from 0.16 to 0.25.

In an especially preferred embodiment of the present invention, the positive active electrode material comprises a mixed oxide represented by the general formula

LiᵥNi_{w}MnₓCo_{y}Al_{z}O₂

wherein
0.95≦v≦1.1,
0.36≦w≦0.46,
0.38≦x≦0.42,
0.12≦y≦0.20,
0.04≦z<0.05,
0.9≦w/x≦1.1 and
0.16≦y+z≦0.25,
more preferably wherein
1≦v≦1.1,
0.38≦w≦0.42 and
w/x=1.

The mixed oxide of the present invention is generally present in the form of particles, which in general have a mean particle diameter D₅₀ of from 0.5 to 30 μm, preferably from 1 to 15 μm, more preferably from 5 to 10 μm.

The mixed oxide of the present invention is generally present in the form of particles, usually having a BET specific surface area (S_{BET}) of from 0.1 to 15 m²/g, preferably from 0.2 to 5 m²/g, more preferably from 0.3 to 1 m2/g.

The structure of the mixed oxide of the invention is commonly a layered crystal structure of the α-NaFeO₂ type (rock-salt crystal structure with the crystallographic space group R3m), in which the O²⁻ ions form a closely packed face-centered cubic structure with the Li ions occupying the 3a sites and the Ni, Mn, Co and Al ions occupying sites crystallographically equivalent to 3b sites. The lattice parameters are typically a=2.851 to 2.875 Å and c=14.17 to 14.30 Å. The unit cell volume V is typically from 100.3 to 102.25 Å³. Said structure was identified by X-ray diffraction (XRD). The X-ray diffractograms were recorded using nickel-filtered CuK_{α} radiation at room temperature with a secondary graphite monochromator in the 2θ range 15-120° in the step scan mode with a step size of 0.02° and a scan rate of 2s/step.

Preferably, the mixed oxide consists mainly of one phase of the α-NaFeO₂ type. The impurities (other kind of phases), from X-ray diffraction analysis, are usually below 15%, especially below 10%, advantageously below 5%.

Another aspect of the present invention relates to processes for the preparation of the positive active electrode materials as described above.

According to this invention, the positive active electrode material as described above may be prepared by a first process comprising the steps of:
(a) at least partially dissolving an appropriate stoichiometric amount of Ni, Co, Mn and Al salts in a liquid solvent so as to obtain a solution or suspension,
(b) co-precipitating a solid from the solution or suspension of step (a) so as to obtain a suspension,
(c) optionally separating the solid formed in co-precipitating step (b) from at least part of the liquid of the suspension resulting from step (b),
(d) mixing a lithium compound with the suspension resulting from step (b) or with the suspension or the solid resulting from optional step (c) so as to form a mixture, and
(e) calcining the mixture resulting from step (d) in the presence of oxygen to form the corresponding mixed oxide.

According to this first process (precipitation process), the liquid solvent in step (a) is usually water, especially distilled water, and the Ni, Co, Mn and Al salts of step (a) are usually selected from the group consisting of nitrates, sulfates, phosphates, acetates and halides such as chlorides, fluorides, iodides, preferably nitrates. The solution or suspension resulting from step (a) often has a concentration of from 1 to 5 mol/l, frequently from 2 to 4 mol/l, for instance around 3 mol/l. Advantageously, substantially all the Ni, Co, Mn and Al salts of step (a) are dissolved into the liquid solvent so as to obtain a solution.

The co-precipitation step (b) of this first process may be conducted by mixing the solution or suspension of step (a) with a hydroxide solution, preferably an aqueous solution comprising sodium hydroxide or ammonium hydroxide or a mixture thereof, in order to precipitate the corresponding mixed (Ni,Mn,Co,Al)-hydroxide. The co-precipitation step (b) may also be conducted by mixing the solution or suspension of step (a) with a carbonate solution, preferably an aqueous solution comprising sodium carbonate, sodium bicarbonate or ammonium hydrogen carbonate or a mixture thereof, in order to precipitate the corresponding mixed (Ni,Mn,Co,Al)-carbonate. The solution or suspension of step (a) can be added to the hydroxide or carbonate solution, or the hydroxide or carbonate solution can be added to the dissolved mixture of step (a). Preferably, the solution or suspension of step (a) is added to the hydroxide or carbonate solution. The pH of the reaction mixture is advantageously from 9 to 14, especially from 10 to 13. Said pH is preferably maintained during the whole co-precipitation process of step (b). The hydroxide or carbonate solution typically has a concentration of from 2 to 6 mol/l, especially from 3 to 5 mol/l. Said hydroxide or carbonate solution is in general mixed with the solution or suspension of step (a) in an amount such that at least 1 mol, preferably at least 2 mol, of hydroxide or of carbonate compound is available per mol of Ni, Co, Mn and Al salt with which it must react to form the corresponding mixed (Ni,Mn,Co,Al)-hydroxide or (Ni,Mn,Co,Al)-carbonate. In a preferred embodiment, 2 mol of hydroxide or 1 mol of carbonate compound is used per mol of Ni, Co, Mn and Al salt. Thus, if the solution or suspension of step (a) comprises one mol of Ni salt, one mol of Co salt, one mol of Mn salt and one mol of al salt, the co-precipitation step can be conducted in the presence of 8 moles of hydroxide or of 4 moles of carbonate compound.

During the co-precipitation step (b) of this first process, the temperature of the overall reaction mixture is preferably kept at a temperature from 20 to 70° C. The solution or suspension of step (a) is preferably added progressively to the hydroxide or carbonate solution. The products are mixed and allowed to react as long as necessary for the reaction to be complete, for instance during from 1 to 5 hour, such as around 3 hours. The mixing is advantageously adapted to allow the formation of a substantially homogeneous solid, “homogeneous” meaning that the Ni, Co, Mn and Al compounds are intermixed with one another.

The co-precipitation step (b) of this first process can be conducted in any suitable reactor, preferably in a closed reactor vessel. Said co-precipitation step (b) is preferably conducted under mixing or stirring of the medium, to insure a good homogeneity of the resulting product.

This first process may further comprise an optional step (c) consisting in separating the solid formed in step (b) from at least part of the liquid. Said optional step (c) may for example be a filtration step comprising the filtration of the reaction mixture resulting from step (b) in order to collect the co-precipitated powder. The filtration step may for instance be conducted on a standard lab filter. Said first process may further comprise a washing step and/or a drying step. The drying step is usually conducted at a temperature from 80 to 100° C. under vacuum.

In this first process of the invention, the lithium compound in step (d) may be selected from the group consisting of lithium oxide, lithium hydroxide, lithium carbonate, lithium nitrate, lithium sulfate, lithium acetate, lithium formate, lithium iodide, and preferably from lithium carbonate, lithium hydroxide and lithium nitrate.

The amount of lithium compound used in step (d) of this first process of the invention is within a range of from 0.9 to 1.2, preferably from 0.95 to 1.1, more preferably from 1 to 1.1 of the combined amounts of the Ni, Mn, Co and Al on a molar basis.

In a preferred embodiment of this first process, the lithium compound used in step (d) is in the form of an aqueous solution which is intermixed with the suspension resulting from step (b) or with the suspension or the solid resulting from step (c). Said solution usually comprises the lithium compound in an amount from 1 to 5 mol/l, preferably from 2 to 3 mol/l. The lithium compound in aqueous solution is preferably added to the suspension resulting from step (b) or to the suspension resulting from step (c) or to the solid resulting from step (c) re-suspended in a liquid, to insure a good homogeneity of the mixing with the lithium compound. The liquid is preferably water. Said suspension typically comprises the solid formed in step (b) in an amount from 30 to 90 wt %, especially from 50 to 80 wt %.

The calcination step (e) of this first process of the invention is generally performed during 2 to 24 hours, preferably during 5 to 16 hours, more preferably during 8 to 12 hours at a temperature of from 700 to 1200° C., especially at a temperature of from 800 to 1100° C., advantageously at a temperature of from 900 to 1000° C., in air or in an oxygen-containing atmosphere. Optionally, prior to calcination step (e), the mixture resulting from step (d) may be dried, for example under vacuum, and preferably under stirring to insure the good homogeneity of the resulting dried powder. It is also possible, prior to calcination step (e), to treat the mixture resulting from step (d) at a temperature of from 400 to 700° C. during 12 to 30 hours in air or in an oxygen-containing atmosphere.

According to this invention, the positive active electrode material as described above may also be prepared by a second process comprising the steps of:

(a) at least partially dissolving an appropriate stoichiometric amount of Li, Ni, Co, Mn and Al salts in a liquid solvent so as to obtain a solution or suspension,
(b) spraying the solution or suspension of step (a) in a flow of gas having a temperature of at least 400° C. so as to obtain a powder, and
(c) calcining the powder resulting from step (b) in the presence of oxygen to form the corresponding mixed oxide.

According to this second process (spray-roasting process), the liquid solvent in step (a) is usually water, especially distilled water. The Ni, Co, Mn and Al salts of step (a) are usually selected from salts which decompose in air at high temperature into metal oxide and gaseous by-products, leaving no non-oxidic impurities coming from the metal anion in the resulting oxide, and preferably from the group consisting of nitrates and acetates, especially nitrates. The Li salt of step (a) is usually selected from the group consisting of lithium hydroxide, lithium nitrate, lithium acetate and lithium formate, preferably from lithium hydroxide and lithium nitrate, more preferably from lithium nitrate. The solution or suspension of step (a) often has a concentration of from 10 to 50 wt %, frequently from 30 to 45 wt %, for instance around 40 wt %. The solution or suspension of step (a), corresponding to the at least partially dissolved Li, Ni, Co, Mn and Al salts in a liquid solvent may also be prepared by at least partially dissolving metal salts in the respective acid. For example, the nitrate salt may be prepared by at least partially dissolving the corresponding metal carbonate or metal hydroxide in diluted nitric acid.

Step (b) of this second process of the invention typically corresponds to so-called spray-roasting. Spray-roasting involves spray atomization of solutions of water-soluble salts into a heated chamber, the result being a high-purity powder with fine particle size. For example, in the present invention, the solution or suspension of step (a) may be spray-roasted in air at temperatures from 400 to 1300° C., preferably from 800 to 1100° C., resulting in the production of the corresponding powder.

The calcination step (c) of this second process of the invention is generally performed during 30 minutes to 24 hours, preferably during 1 to 15 hours, for example during 1 to 5 hours or during 8 to 12 hours, depending on the temperature. The calcination step (c) is usually conducted at a temperature of from 700 to 1200° C., especially at a temperature of from 800 to 1100° C., advantageously at a temperature of from 900 to 1000° C., in an oxygen-containing atmosphere, such as air. In some embodiment, the calcination step of this second process of the invention may be performed during 2 to 24 hours, preferably during 5 to 16 hours, more preferably during 8 to 12 hours at a temperature of from 700 to 1200° C., especially at a temperature of from 800 to 1100° C., advantageously at a temperature of from 900 to 1000° C., in an oxygen-containing atmosphere such as air.

The positive active electrode material of the invention is especially suitable for the preparation of positive electrode materials for lithium secondary batteries, also named rechargeable lithium ion batteries. The present invention therefore also relates to lithium secondary batteries comprising:
a positive electrode (or cathode) at least made of the positive active electrode material of the present invention,
a negative electrode and
a non-aqueous electrolyte.

In said lithium secondary batteries, the positive electrode (or cathode), which reversibly absorbs and releases lithium ions, typically further comprises a binder.

The binder binds the active material particles together and also the positive active material to an optional positive current collector. The binder is usually a polymeric binder such as polytetrafluroethylene (PTFE), polyvinylidene fluoride (PVDF), polyvinylalcohol (PVA), polyvinylchloride (PVC), polyethylene (PE), polypropylene (PP), polyvinylpyrrolidone, styrene-butadiene rubber, carboxymethylcellulose, hydroxypropylcellulose, diacetylenecellulose or any other suitable binder. The positive electrode may also contain an optional conducting agent such as natural graphite, artificial graphite, carbon black, acetylene black, ketjen black, a carbon fiber, a metal powder (for example copper, nickel, aluminum, silver, gold etc) or a metal fiber including copper, nickel, aluminum, silver etc, a polyphenylene derivative, or combinations thereof.

The lithium secondary batteries of the present invention also comprise a negative electrode, which usually comprises, as negative active material, at least one selected from the group consisting of a carbonaceous material, lithium metal, a lithium alloy, a material being capable of reversibly forming a lithium-containing compound, and combinations thereof. The negative active material often comprises a carbonaceous material. The carbonaceous material may be, for example, amorphous carbon, crystalline carbon or a graphite fiber. The lithium alloy that may be included in the negative active material may include Li and a metal selected from the group consisting of Na, K, Rb, Cs, Fr, Be, Mg, Ca, Sr, Ba, Ra, Al, Fe, and Sn. Examples of materials capable of reversibly forming a lithium-containing compound by reaction with lithium ions include, among others, tin, tin oxides, titanium nitrate, silicon, silicon oxides, composite tin alloys, transition metal oxides, lithium metal nitrides and lithium metal oxides such as lithium vanadium oxides. The negative electrode also usually comprises a binder and optionally a conductive agent. The binder and the conductive agent are the same as described with respect to the positive electrode and therefore their descriptions are not provided.

The non-aqueous electrolyte of the lithium secondary batteries of the present invention usually comprises a solvent and a solute, the solute preferably containing at least one type of fluorine-containing compound.

In the electrolyte, the solvent acts as a medium for transmitting ions taking part in the electrochemical reaction of the battery. The solvent may include a carbonate-based, ester-based, ether-based, ketone-based, alcohol-based, aromatic hydrocarbon-based, or aprotic solvent. Often, the solvent includes at least a carbonate-based solvent, which may be combined with another kind of solvent such as aromatic hydrocarbon-based solvents. Examples of carbonate-based solvent may include ethylene carbonate (EC), propylene carbonate (PC), butylene carbonate (BC), dimethyl carbonate (DMC), diethyl carbonate (DEC), dipropyl carbonate (DPC), methyl ethyl carbonate (MEC), ethyl methyl carbonate (EMC), methyl propyl carbonate (MPC), ethyl propyl carbonate (EPC), polyethylene carbonate, vinylene carbonate, vinyl ethylene carbonate, chloroethylene carbonate, etc. Examples of ester-based solvents are methyl formate, methyl acetate, methyl butyrate, n-ethyl acetate, n-propyl acetate, dimethylacetate, methylpropionate, ethylpropionate, methyl difluoroacetate, γ-bytyrolactone, decanolide, valerolactone, mevalonolactone, caprolactone, etc. Examples of ether-based solvents are dibutyl ether, 1,3-dioxane, 1,4-dioxane, 1,2-dimethoxyethane, 1,4- dibutoxyethane, tetraglyme, diglyme, dimethoxyethane, 2-methyltetrahydrofuran, tetrahydrofuran, ethyl nonafluorobutyl ether, etc. Examples of ketone-based solvent include cyclohexanone, polymethylvinyl ketone, etc. Examples of alcohol-based solvent include ethyl alcohol, isopropyl alcohol, etc. Examples of aromatic hydrocarbon-based solvents include benzene, toluene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, and xylene. Examples of aprotic solvent include nitriles, such as R—CN (wherein R is a C2 to C20 linear, branched, or cyclic hydrocarbon, a carbon chain including double bonds, an aromatic ring, or a carbon chain including ether bonds), especially acetonitrile or benzonitrile, amides such as dimethylformamide, dioxolanes, such as 1,3-dioxolane, sulfolanes, siloxanes, vinyl pyridine, etc. The solvent may be used singularly or in a mixture.

The solute is advantageously at least one lithium salt, the role of which notably facilitates the transmission of lithium ions between the positive and negative electrodes. The lithium salt can for example be selected from the group consisting of LiBF₄, LiClO₄, LiAlO₄, LiAlCl₄, LiPF₆, LiSbF₆, LiAsF₆, LiCF₃SO₃, LiC₄F₉SO₃, LiB(C₂O₄)₂, LiN(C₂F₅SO₂)₂, LiN(CF₃SO₂)₂, LiN(CₓF₂ₓ₊₁SO₂)(C_{y}F_{2y+1}SO₂) wherein x and y are positive integers, LiCl, LiI, lithium bisoxalate borate, and mixtures thereof

The solute is generally present in an amount of from 0.1 to 5.0 mol/l of the non-aqueous electrolyte solution, often from 0.5 to 2.0 mol /l, for example from 0.8 to 1.4 mol/l.

The lithium secondary batteries of the present invention may further comprise:
a sealable cell container,
a separator,
a positive electrode current collector, and
a negative electrode current collector.

The separator may include any material used in conventional lithium secondary batteries, for example polyethylene, polypropylene, polyvinylidene fluoride, polyethylene terephthalate, and multi-layers thereof. Examples of positive current collectors are foils, films, sheets, nets, or other kind of bodies made of aluminum, titanium, stainless steel, nickel, conductive polymers, electrically conductive glass etc. The negative current collector may be, for instance, a foil, film, sheet, net, or any other body made of copper, nickel, iron, stainless steel, titanium, aluminum, carbon, a conductive polymer, electrically conductive glass, Al—Cd alloy etc.

The rechargeable lithium batteries may have a variety of shapes and sizes, including cylindrical, prismatic, or coin-type batteries and may be a thin film battery or larger in size.

In view of the above, the present invention also relates to the use of the positive active electrode material of the invention for the preparation of positive electrodes to be used in lithium secondary batteries.

The present invention is further illustrated below without limiting the scope thereto.

Should the disclosure of any patents, patent applications, and publications which are incorporated herein by reference conflict with the description of the present application to the extent that it might render a term unclear, the present description shall take precedence.

### EXAMPLES

### Examples 1-2

### Precipitation Process

Two samples of mixed oxides of the stoichiometry summarized in Table I below were prepared using the precipitation process.

TABLE I

| Examples | Mixed oxide |
|---|---|
| 1 | Li_{1.06}Ni_{0.32}Mn_{0.34}Co_{0.34}O₂ |
| 2 | Li_{1.09}Ni_{0.38}Mn_{0.39}Co_{0.19}Al_{0.04}O₂ |

Appropriate stoichiometric amounts of Ni (II) nitrate, Co (II) nitrate, Mn (II) nitrate and optionally Al (III) nitrate were dissolved in water at a temperature about 25° C., the total concentration of the nitrate salts being around 3.0 mol/l. Said solution of mixed salts was then added to an amount of 2 mol of sodium hydroxide (concentration=4 mol/l) per mol of the dissolved salts, over a time span of 50 minutes and at a temperature of 30° C. This resulted in the co-precipitation of the corresponding hydroxides, leading to the corresponding mixed (Ni,Mn,Co,Al)-hydroxide. The precipitate was filtered on a standard lab filter and washed with distilled water until the filter cake was free of Na⁺ and NO₃⁻. The resulting product was dried under vacuum at 80° C. during 20 hours.

The dry (Ni,Mn,Co,Al)-hydroxide powder was suspended in distilled water, at a concentration of 70 wt-%, and lithium hydroxide aqueous solution (with a concentration of 4 mol/l) was added in an amount such that the exact requested final stoichiometric proportion was obtained in the mixture. The (Ni,Mn,Co,Al)-hydroxide and the lithium hydroxide were mixed together and dried at a temperature of 90° C., under vacuum. The mixture of lithium hydroxide and (Ni,Mn,Co,Al)-hydroxide was homogenised in a ball mill and then calcined at 970° C. under air atmosphere for approximately 12 hours, giving the corresponding (Li,Ni,Mn,Co,Al)-oxide. Examples 3-4

### Spray-Roasting Process

Two samples of mixed oxides of the stoichiometry summarized in Table II below were prepared using the spray-roasting process.

TABLE II

| Examples | Mixed oxide stoichiometry |
|---|---|
| 3 | Li_{1.08}Ni_{0.38}Mn_{0.38}Co_{0.20}Al_{0.04}O₂ |
| 4 | Li_{1.04}Ni_{0.38}Mn_{0.38}Co_{0.20}Al_{0.04}O₂ |

Appropriate stoichiometric amounts of lithium nitrate, Ni (II) nitrate, Co (II) nitrate, Mn (II) nitrate and optionally Al (III) nitrate were dissolved in water at a temperature about 25° C., the total concentration of the salts being around 4 mol/l. Said solution of mixed salts was then sprayed in a flow of hot gas (spray-roasting) at a temperature of 1050° C. This resulting powder was then calcined at 970° C. under air atmosphere for approximately 1 hour, giving the corresponding (Li,Ni,Mn,Co,Al)-oxide.

### Characterization of Samples 1-4

### Chemical Analysis

The stoichiometries of the resulting mixed oxides were determined by the chemical analysis of the resulting mixed oxides, especially by ICP-OES. The results for examples 1 to 4 are summarized in the Table III below.

TABLE III

| Examples | Li | Ni | Mn | Co | Al |
|---|---|---|---|---|---|
| 1 | 1.06 | 0.32 | 0.34 | 0.34 | 0 |
| 2 | 1.09 | 0.38 | 0.39 | 0.19 | 0.04 |
| 3 | 1.08 | 0.38 | 0.38 | 0.20 | 0.04 |
| 4 | 1.04 | 0.38 | 0.38 | 0.20 | 0.04 |

### XRD Phase Analysis

The X-ray diffractograms were recorded on a Siemens D5000 apparatus using nickel-filtered CuK_{α1/2} radiation at room temperature with a secondary graphite monochromator in the 2θ ranges 15-120° in the step scan mode with a step size of 0.02° and a scan rate of 2s/step (Software (Rietveld) Topas 2.1).

The results of the X-ray diffraction analysis are summarized in Table IV below. These results are expressed as the lattice parameters a and c (Å), as unit cell volume V (Å³). No other phase than the α-NaFeO₂ type could be identified.

TABLE IV

| | | | | Other phase |
|---|---|---|---|---|
| Examples | a (Å) | c (Å) | V (Å³) | than α-NaFeO₂ |
| 1 | 2.861 | 14.238 | 100.91 | No |
| 2 | 2.866 | 14.253 | 101.37 | No |
| 3 | 2.866 | 14.252 | 101.42 | No |
| 4 | 2.869 | 14.261 | 101.66 | No |

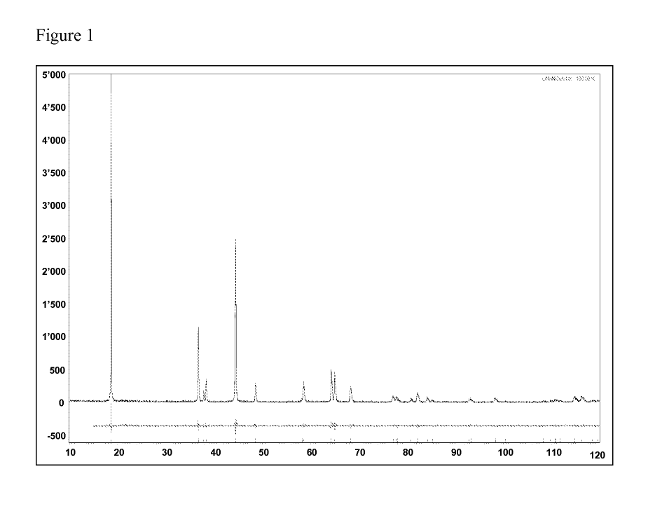

The XRD graph of sample 2 is shown in FIG. 1. This graph confirms the α-NaFeO₂ structure type of example 2. Similar graphs were obtained for examples 1, 3 and 4.

### Electrochemical Characterization

The electrochemical behavior of the samples was tested by galvanostatic cycling of the materials.

For electrochemical characterization, electrodes were prepared as follows: 20 wt-% Hostaflon 2020 (binder), 20 wt-% acetylene black (conductive agent) and 60 wt-% active material were homogenised in a mortar. The resulting mixture was pressed into an Al-net at 10 t to obtain the electrode. The electrode was dried a 90° C. under vacuum for 12 h before electrochemical characterization. The electrochemical characterization was performed galvanostatically at C/20 in a standard electrolyte of 1 M LiPF₆ in ethylene carbonate (EC): dimethyl carbonate (DMC) 1:1. The potential window was between 3.0 and 4.4 V vs Li/Li⁺.

The results obtained for the maximum discharge capacity are summarized in Table V below.

TABLE V

| | Maximum discharge |
|---|---|
| Examples | capacity (mAh/g) |
| 1 | 164 |
| 2 | 165 |
| 3 | 161 |
| 4 | 163 |

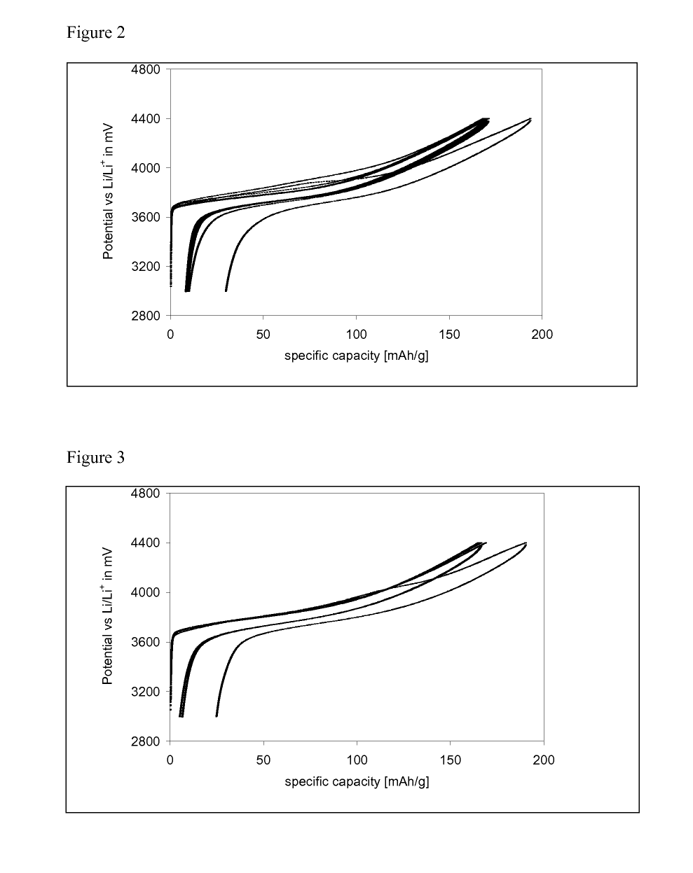

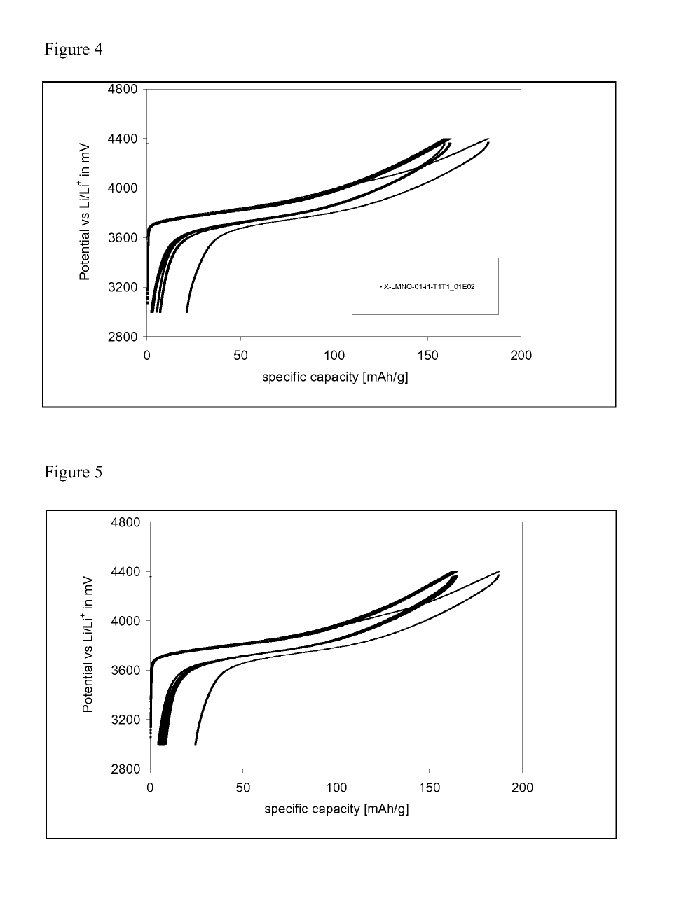

Charge-discharge cycles of samples 1 to 4 are shown respectively in FIGS. 2 to 5.

### Examples 5-57

### Preparation of Various Positive Active Electrode Materials

LiNiMnCoAl mixed oxides having the stoichiometries summarized in Table VI below and a stoichiometric amount of Li comprised between 1.0 and 1.1 are prepared using the precipitation process or spray-roasting process described above.

TABLE VI

| Examples | Mixed oxide stoichiometry |
|---|---|
| 5 | LiNi_{0.48}Mn_{0.42}Co_{0.06}Al_{0.04}O₂ |
| 6 | LiNi_{0.47}Mn_{0.42}Co_{0.07}Al_{0.04}O₂ |
| 7 | LiNi_{0.46}Mn_{0.42}Co_{0.08}Al_{0.04}O₂ |
| 8 | LiNi_{0.45}Mn_{0.42}Co_{0.09}Al_{0.04}O₂ |
| 9 | LiNi_{0.44}Mn_{0.42}Co_{0.10}Al_{0.04}O₂ |
| 10 | LiNi_{0.43}Mn_{0.42}Co_{0.11}Al_{0.04}O₂ |
| 11 | LiNi_{0.42}Mn_{0.42}Co_{0.12}Al_{0.04}O₂ |
| 12 | LiNi_{0.41}Mn_{0.42}Co_{0.13}Al_{0.04}O₂ |
| 13 | LiNi_{0.40}Mn_{0.42}Co_{0.14}Al_{0.04}O₂ |
| 14 | LiNi_{0.39}Mn_{0.42}Co_{0.15}Al_{0.04}O₂ |
| 15 | LiNi_{0.38}Mn_{0.42}Co_{0.16}Al_{0.04}O₂ |
| 16 | LiNi_{0.37}Mn_{0.42}Co_{0.17}Al_{0.04}O₂ |
| 17 | LiNi_{0.36}Mn_{0.42}Co_{0.18}Al_{0.04}O₂ |
| 18 | LiNi_{0.35}Mn_{0.42}Co_{0.19}Al_{0.04}O₂ |
| 19 | LiNi_{0.34}Mn_{0.42}Co_{0.20}Al_{0.04}O₂ |
| 20 | LiNi_{0.33}Mn_{0.42}Co_{0.21}Al_{0.04}O₂ |
| 21 | LiNi_{0.32}Mn_{0.42}CO_{0.22}Al_{0.04}O₂ |
| 22 | LiNi_{0.31}Mn_{0.42}Co_{0.23}Al_{0.04}O₂ |
| 23 | LiNi_{0.30}Mn_{0.42}Co_{0.24}Al_{0.04}O₂ |
| 24 | LiNi_{0.28}Mn_{0.42}Co_{0.26}Al_{0.04}O₂ |
| 25 | LiNi_{0.42}Mn_{0.44}Co_{0.10}Al_{0.04}O₂ |
| 26 | LiNi_{0.42}Mn_{0.43}Co_{0.11}Al_{0.04}O₂ |
| 27 | LiNi_{0.42}Mn_{0.42}Co_{0.12}Al_{0.04}O₂ |
| 28 | LiNi_{0.42}Mn_{0.41}Co_{0.13}Al_{0.04}O₂ |
| 29 | LiNi_{0.42}Mn_{0.40}Co_{0.14}Al_{0.04}O₂ |
| 30 | LiNi_{0.42}Mn_{0.39}Co_{0.15}Al_{0.04}O₂ |
| 31 | LiNi_{0.42}Mn_{0.38}Co_{0.16}Al_{0.04}O₂ |
| 32 | LiNi_{0.42}Mn_{0.37}Co_{0.17}Al_{0.04}O₂ |
| 33 | LiNi_{0.42}Mn_{0.36}Co_{0.18}Al_{0.04}O₂ |
| 34 | LiNi_{0.42}Mn_{0.35}Co_{0.19}Al_{0.04}O₂ |
| 35 | LiNi_{0.42}Mn_{0.34}Co_{0.20}Al_{0.04}O₂ |
| 36 | LiNi_{0.41}Mn_{0.33}Co_{0.22}Al_{0.04}O₂ |
| 37 | LiNi_{0.41}Mn_{0.32}Co_{0.23}Al_{0.04}O₂ |
| 38 | LiNi_{0.43}Mn_{0.43}Co_{0.10}Al_{0.04}O₂ |
| 39 | LiNi_{0.41}Mn_{0.41}Co_{0.14}Al_{0.04}O₂ |
| 40 | LiNi_{0.40}Mn_{0.40}Co_{0.16}Al_{0.04}O₂ |
| 41 | LiNi_{0.39}Mn_{0.39}Co_{0.18}Al_{0.04}O₂ |
| 42 | LiNi_{0.37}Mn_{0.37}Co_{0.22}Al_{0.04}O₂ |
| 43 | LiNi_{0.36}Mn_{0.36}Co_{0.24}Al_{0.04}O₂ |
| 44 | LiNi_{0.36}Mn_{0.40}Co_{0.20}Al_{0.04}O₂ |
| 45 | LiNi_{0.37}Mn_{0.39}Co_{0.20}Al_{0.04}O₂ |
| 46 | LiNi_{0.39}Mn_{0.37}Co_{0.20}Al_{0.04}O₂ |
| 47 | LiNi_{0.40}Mn_{0.36}Co_{0.20}Al_{0.04}O₂ |
| 48 | LiNi_{0.41}Mn_{0.35}Co_{0.20}Al_{0.04}O₂ |
| 49 | LiNi_{0.42}Mn_{0.34}Co_{0.20}Al_{0.04}O₂ |
| 50 | LiNi_{0.43}Mn_{0.33}Co_{0.20}Al_{0.04}O₂ |
| 51 | LiNi_{0.44}Mn_{0.32}Co_{0.20}Al_{0.04}O₂ |
| 52 | LiNi_{0.45}Mn_{0.31}Co_{0.20}Al_{0.04}O₂ |
| 53 | LiNi_{0.46}Mn_{0.30}Co_{0.20}Al_{0.04}O₂ |
| 54 | LiNi_{0.47}Mn_{0.29}Co_{0.20}Al_{0.04}O₂ |
| 55 | LiNi_{0.48}Mn_{0.28}Co_{0.20}Al_{0.04}O₂ |
| 56 | LiNi_{0.49}Mn_{0.27}Co_{0.20}Al_{0.04}O₂ |
| 57 | LiNi_{0.50}Mn_{0.26}Co_{0.20}Al_{0.04}O₂ |

1. A positive active electrode material for lithium secondary batteries comprising a mixed oxide represented by the general formula
LiᵥNi_{w}MnₓCo_{y}Al_{z}O₂
wherein
0.9≦v≦1.2,
0.34≦w≦0.49,
0.34≦x≦0.42,
0.08≦y≦0.20,
0.03≦z<0.05,
0.8≦w/x≦1.8,
−0.08≦w−x≦0.22,
0.12≦y+z0.25 and
w+x+y+z=1.

2. The positive active electrode material according to claim 1, wherein the mixed oxide is represented by the general formula
LiᵥNi_{w}MnₓCo_{y}Al_{z}O₂
wherein
0.95≦v≦1.1,
0.36≦w≦0.46,
0.38≦x≦0.42,
0.12≦y≦0.20,
0.04≦z<0.05,
0.9≦w/x≦1.1,
0.16≦y+z≦0.25.

3. The positive active electrode material according to claim 1, wherein the mixed oxide is present in the form of particles having a mean particle diameter D₅₀ of from 0.5 to 30 μm.

4. The positive active electrode material according to claim 1, wherein the mixed oxide is present in the form of particles having a BET specific surface area of from 0.1 to 15 m²/g.

5. The positive active electrode material according to claim 1, wherein the mixed oxide has a layered structure of the α-NaFeO₂ type.

6. A process for preparing the positive active electrode material according to claim 1, comprising the steps of:
(a) at least partially dissolving an appropriate stoichiometric amount of Ni, Co, Mn and Al salts in a liquid solvent so as to obtain a solution or suspension,
(b) co-precipitating a solid from the solution or suspension of step (a) so as to obtain a suspension,
(c) optionally separating the solid formed in said co-precipitating step (b) from at least part of the liquid of the suspension resulting from step (b),
(d) mixing a lithium compound with the suspension resulting from step (b) or with the suspension or the solid resulting from optional step (c) so as to form a mixture, and
(e) calcining the mixture resulting from step (d) in the presence of oxygen to form the corresponding mixed oxide.

7. The process according to claim 6, wherein the liquid solvent of step (a) is water, and wherein the Ni, Co, Mn and Al salts of step (a) are selected from the group consisting of nitrates, sulfates, phosphates, acetates, and halides.

8. The process according to claim 6, wherein a hydroxide or a carbonate solution is mixed with the solution or suspension resulting from step (a) during the co-precipitation step (b).

9. The process according to claim 6, wherein the lithium compound added in step (d) is selected from the group consisting of lithium oxide, lithium hydroxide, lithium carbonate, lithium nitrate, lithium sulfate, lithium acetate, lithium formate, and lithium iodide.

10. A process for preparing the positive active electrode material according to claim 1, comprising the steps of:
(a) at least partially dissolving an appropriate stoichiometric amount of Li, Ni, Co, Mn and Al salts in a liquid solvent so as to obtain a solution or suspension,
(b) spraying the solution or suspension of step (a) in a flow of gas having a temperature of at least 400° C. so as to obtain a powder, and
(c) calcining the powder resulting from step (b) in the presence of oxygen to form the corresponding mixed oxide.

11. The process according to claim 10, wherein the liquid solvent of step (a) is water; wherein the Ni, Co, Mn and Al salts of step (a) are selected from the group consisting of nitrates and acetates; and wherein the Li salt of step (a) is selected from the group consisting of lithium hydroxide, lithium nitrate, lithium acetate, and lithium formate.

12. The process according to claim 10, wherein said spraying step (b) corresponds to spray-roasting.

13. The process according to claim 6, wherein the calcination step (e) is performed during a time period from 2 to 24 hours, at a temperature of from 700 to 1200° C., in an oxygen-containing atmosphere.

14. A lithium secondary battery comprising:
a positive electrode at least made of the positive active electrode material of claim 1,
a negative electrode and
a non-aqueous electrolyte.

15. A method for the preparation of a positive electrode to be used in lithium secondary batteries, comprising using the positive active electrode material of claim 1 and a binder to prepare said positive electrode, wherein the binder binds particles of said positive active electrode material together.

16. The process according to claim 7, wherein the Ni, Co, Mn and Al salts of step (a) are selected from the group consisting of chlorides, fluorides, iodides, and nitrates.

17. The process according to claim 11, wherein the Ni, Co, Mn and Al salts of step (a) are nitrates; and wherein the Li salt of step (a) is selected from the group consisting of lithium hydroxide and lithium nitrate.

18. The process according to claim 12, wherein step (b) corresponds to spray-roasting in air.

19. The process according to claim 10, wherein the calcination step (c) is performed during a time period from 30 minutes to 24 hours at a temperature of from 700 to 1200° C. in an oxygen-containing atmosphere.
